(19) United States
(12) Patent Application Publication
(10) Pub. No.: US 2017/0101253 A1
(43) Pub. Date: Apr. 13, 2017

(54) MULTICHAMBER BAG OPENING AID

(71) Applicant: Fresenius Medical Care Deutschland GmbH, Bad Homburg (DE)

(72) Inventors: Thomas FAULHABER, Bergrheinfeld (DE); Eva BRUDER, Oberursel (DE); Klaus WOLF, Arnstein (DE); Markus ROBERTZ, Hofheim (DE)

(73) Assignee: Fresenius Medical Care Deutschland GmbH, Bad Homburg (DE)

(21) Appl. No.: 15/128,441

(22) PCT Filed: Apr. 15, 2015
(86) PCT No.: PCT/EP2015/058159

§ 371 Date: Sep. 23, 2016

(30) Foreign Application Priority Data
Apr. 16, 2014 (DE) 10 2014 005 569.8

(51) Int. Cl. B65D 81/32; A61J 1/20; B65D 75/58; A61J 1/10

(52) U.S. Cl. CPC B65D 81/3266; A61J 1/10; A61J 1/2093; B65D 75/5855

(57) ABSTRACT

The present invention describes a multichamber bag opening aid for opening multichamber bag systems.

The present invention relates to a device for opening bags and for mixing the contents of bags.

Consumer goods are packaged in bags in many situations in everyday life. Bags with multiple compartments or chambers for holding different ingredients are also being used to an increasing extent. This may be advantageous in particular when the individually packaged components of a preparation have a better stability in storage than the ready-to-use product. This is of great importance for pharmaceutical preparations in particular, such as nutrient solutions or dialysis solutions, which contain different substances with which chemical or physical reactions may occur between the individual substances over a period of time and can lead to incompatibilities and may thus impair the efficacy and tolerability of the product. It is customary in such cases to package the different components of a preparation in individual chambers according to their compatibility and to combine them only just before their use to form a ready-to-use product. The individual chambers may be filled preferably with different fluids, and one or more chambers may also contain a solid.

Plastic bags in particular are used as the packaging material, wherein the individual chambers inside the bag may be opened and the separately packaged ingredients may thus be combined to a ready-to-use product. The plastic bags may be used in the fields of foods, beverages and pharmaceuticals. To open the chambers, they may be interconnected with so-called breaking cones, for example. Fluid paths are created between the chambers by breaking open the cones, allowing the individual fluids to be mixed and/or permitting reconstitution of one or more solids. However, the use of breaking cones has the disadvantage that, among other things, particles that may be formed when the cones are broken open may lead to contamination of the product in the case of medical solutions, for example. Therefore, bags which have peel seams or sealing seams have become established for opening and mixing between the individual chambers. The peel seams or sealing seams between the chambers have a lower sealing strength than the external seams on the bag. By applying pressure to one or more chambers, the peel seams are broken open completely or at least partially and allow a fluid connection to be established between the chambers and allow mixing of the individual components before the ready-to-use product has been removed. The sealing strength of the peel seams between the chambers is to be selected, so that the seams cannot tear open unintentionally in transport and handling of the bags, but it must still easy to open the peel seams by hand with a reasonable expenditure of force. In the case of bags with a total fill volume of more than one liter content, a partial area of the bag is usually rolled up from its edge area, for example, from the side edge or a corner of the film, to thereby compress the contents of the chamber, so that the pressure inside the bag on the peel seams rises and they break open when the sealing pressure is exceeded.

One example of a multichamber plastic bag, in which individual chambers are separated from one another by peel seams is described in EP 1396249 A2.

For a normal healthy adult user, there is not usually any problem with opening and mixing a multichamber plastic bag provided with peel seams. Nevertheless, opening such bags may be tedious for certain people, such as the elderly or those of diminished capacity because it might be difficult for them to apply the proper force and/or they may have problems in handling the opening procedure because of motor restrictions.

Therefore, people who cannot apply a sufficiently great force to one or more chambers of a multichamber baa and/or have only a limited motor capacity are presented with the problem that they find it difficult to roll up a portion of the bag from the edge area, for example, starting from a film side, preferably a film corner. At the same time, they must hold the partially rolled-up bag area securely and in addition apply a corresponding pressure to roll it up again and/or to compress it until the peel seams break open. This problem may occur to a greater extent, in particular with large bags having a capacity of two or more liters.

One possibility for opening a peel seam in a double chamber bag is disclosed in JP 2007-054108 wherein a connector protection extends over the first chamber of the bag. By applying pressure to the enlarged/widened area of connector protection, the peel seam can be broken open.

GE 337440 A discloses a key-like device having a slot for opening an outer package containing a glass bottle. The outer package has a tear strip whose protruding end is inserted Into the slot in the key to thereby open the outer package by turning the tear strip around the key.

The object of the invention is now to make available a device and a method which will provide a simple and inexpensive aid for opening peel seams in multichamber bag systems and mixing the individual bag contents/of the bag.

This object is achieved by the subject matter of claim 1, wherein opening of peel seams in a multichamber bag system for producing a fluid connection between the separated chambers and for simultaneously mixing the individual components is facilitated by means of a device, which is designed as a multichamber bag opening aid, comprising a rod-shaped central part with two distal handle elements.

This object is additionally achieved by a method according to claim 15.

Additional advantageous embodiments of the invention are derived from the dependent claims.

Multichamber bag systems such as those used in the sense of the invention are also referred to below as bags or bag systems comprising two or more chambers, wherein the individual chambers or chambers are separated from one another by peel seams, and the bag additionally has at least one removal device and preferably additionally at least one feed device. Bag systems such as those used in conjunction with the subject matter according to the invention are typically made of a thermoplastic material.

It is also possible to provide that, the peel systems of the multichamber bag systems are broken open in an intended sequence. This is the case when the peel seams have a seal strength that increases according to the opening sequence.

To overcome the disadvantages described above when opening a multichamber bag system, a multichamber bag opening aid is provided, comprising a rod-shaped central part and two distal handle elements, with the help of which a partial area of a bag, in particular an edge area such as a film side or a film corner can be rolled up over the central part of the multichamber bag opening aid, and the contents of the chambers can be compressed so that the peel seams break open between the individual chambers, the handle elements serve to permit stabilisation and transfer of force and to simply roll up the partial area of the bag.

For the group of people described above in particular, the multichamber opening aid facilitates the operation and thus permits improved handling in opening multichamber bag systems and allows these people to maintain their independence in performing their therapeutic measures.

To further optimize the process of rolling up a multi-chamber bag system, means for fixation of a partial area of a multichamber bag may be provided in the central part.

The means for fixation may be designed in the form of an indentation capable of receiving a film corner of a multichamber bag, for example. In addition, the partial area of the bag can be secured in the indentation in the central part by a movable clamping element.

Alternatively, a milled groove in the form of a wedge-shaped recess may be provided in the central part. A clamping element may protrude over the wedge-shaped recess to some extent as a means of securing a partial area of a multichamber bag, so that a partial area of a bag, in particular a film corner, can be held securely between a wedge-shaped recess formed by the milled groove and the clamping element. By operating the handle elements, a partial area of the multichamber bag system can be rolled up very easily around the central part of the multichamber bag opening aid until the sealing pressure of the peel seams has been overcome, the peel seams break open and it becomes possible to mix the individual components. This additionally facilitates the handling of the multichamber bag opening aid and reliably prevents slippage of the bag film.

The device according to the invention is explained in greater detail below with reference to the drawings.

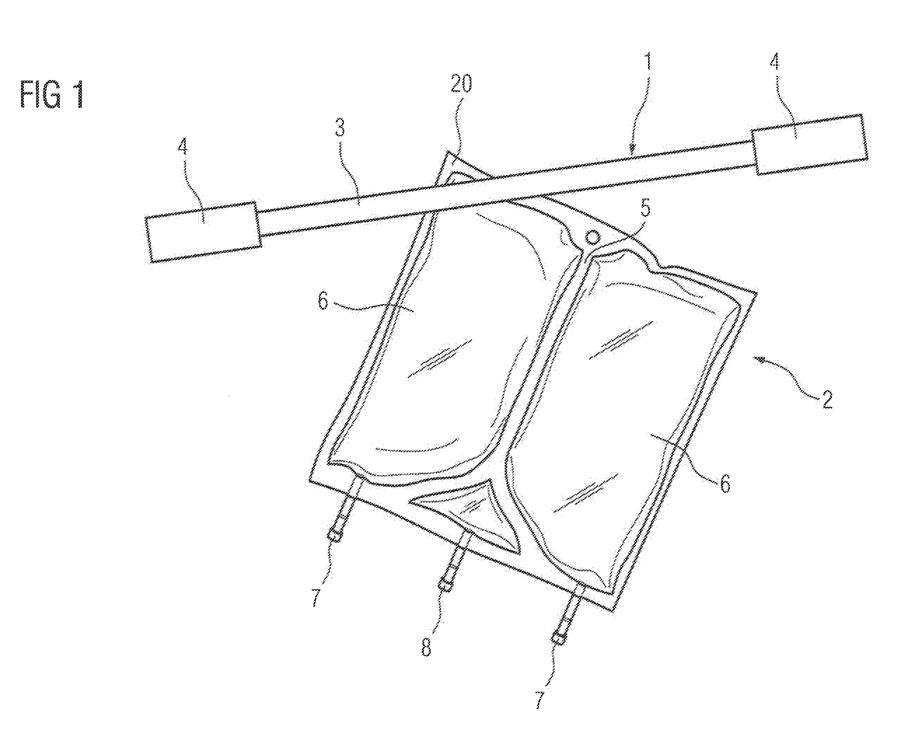

FIG. 1 shows a multichamber bag system with a multichamber bag opening aid.

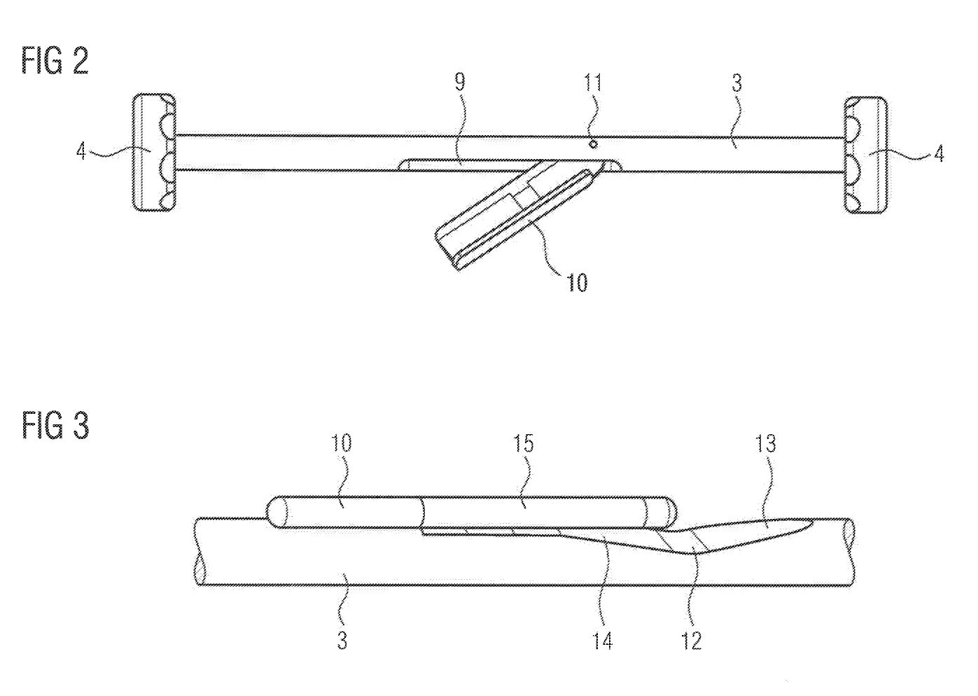

FIG. 2 shows a multichamber bag opening aid with handle elements and an indentation in the central part as well as a movable clamping element for securing the bag film.

FIG. 3 shows a partial area of the central part of a multichamber bag opening aid with a milled, groove and a clamping element.

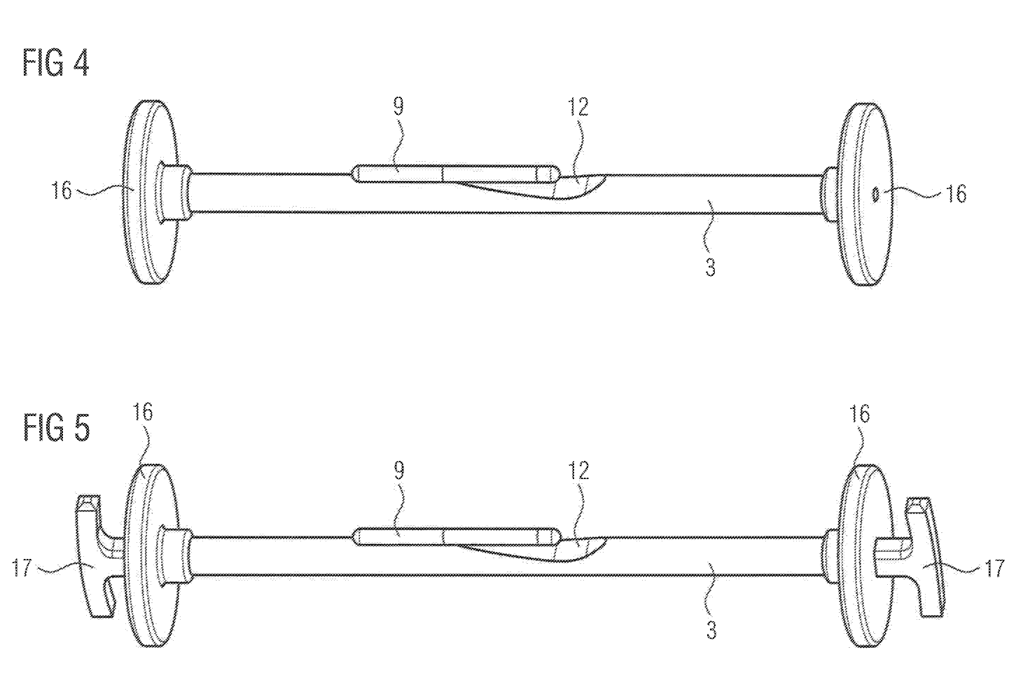

FIGS. 4 to 6 show additional embodiments of the multichamber bag opening aid with alternative handle elements.

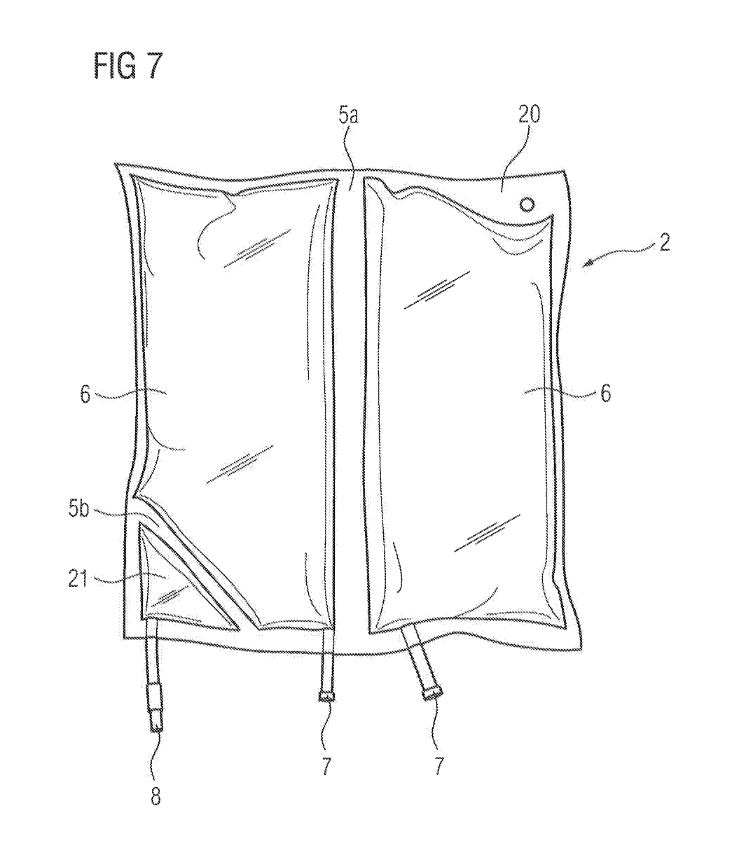

FIG. 7 shows another multichamber bag system, having peel seams.

In a first embodiment as shown in FIG. 1, a multichamber bag opening aid (1) is provided and forms a multichamber bag system (2). The multichamber bag opening aid (1) comprising a rod-shaped central part (3) with two distal handle elements (4) serves to permit simplified opening of peel seams (5) in a multichamber bag system (2) and mixing of the individual bag contents. The rod-shaped central part (3) may be designed in the form of a solid pipe or a hollow pipe or even as a telescoping rod.

The bag system (2) has, for example, two separate fluid-filled bag chambers (6) which are separated from one another by the peel seam (5). However, the individual chambers or compartments of the bag system may also be filled with a solid and a liquid. The multichamber bag system (2) additional comprises other feed devices (7) and removal devices (8).

In addition, means for fixation of a partial, area (20) of a multichamber bag (2) may also be provided in the central part (3), where an edge area of the multichamber bag (2) may preferably be understood to be a film side or a film corner as the partial area (20).

In a second embodiment as illustrated in FIG. 2, the central part (3) may have an indentation (9) as the means for fixation. The indentation (9) serves to receive a partial area of a multichamber bag system (2). In particular the indentation (9) is suitable for accommodating an edge area, preferably a film side or film corner of a multichamber bag as the partial area and thus simplifying the rollup operation. The indentation (9) may then penetrate the central part (3) completely or partially in the longitudinal direction, for example, up to three-fourths, one-half or one-fourth of the diameter of the central part (3). The indentation (9) is advantageously provided at the center between the handle elements (4).

In another more extensive embodiment, a clamping element (10) for insertion into the indentation (9) may also be provided as a component of the means for fixation. The clamping element (10) may be movable, for example, it may preferably be mounted so it can rotate on the central part (3) to be able to engage in the indentation (9) over a pivot point (11). The partial area (20) of the bag system (2) inserted into the indentation (9), in particular a film corner, may be clamped by means of the clamping element (10) in this way and thus fixed securely, so that slippage of the film is prevented and the rollup process is further simplified.

To prevent damage to the bag film on insertion and clamping in the indentation (9), both, the edges of the indentation (9) as well as the edges of the clamping element (10) are preferably chamfered and rounded.

FIG. 3 shows a third alternative embodiment of a multi-chamber bag opening aid (2) in a partial view, where the central part (3) has a notch designed to form a wedge-shaped recess (12) in the central part (3), this recess optionally having a symmetrical shape. The wedge-shaped recess (12) preferably has an asymmetrical shape, which has a steeper degree of notch on a first end (13) than on a second end (14). The thickness of the wedge-shaped recess (12) depends on the thickness of the film of the bag to be clamped, and at its lowest point, may have a height of 1.0 mm to 0.2 mm, preferably from 0.8 mm to 0.4 mm, especially preferably from 0.6 to 0.2 mm up to the upper edge of the central part (3).

As the means for fixation of a partial area (20) of a multichamber bag system (2), a clamping element (10) may protrude beyond the wedge-shaped recess (12) to some extent, wherein the clamping element (10) may exceed, the length of the recess (12) by two-thirds or three-fourths. The clamping element (10) may protrude beyond, the recess (12) by as much as one-half. The clamping element (10) also serves to provide a clamping effect, for example, of a film corner, and is permanently mounted on the central part (3). The clamping element (10) may be secured, on the central part (3) by rivets or screws.

This clamping construction of a wedge-shaped recess (12) and clamping element (10) has the advantage that insertion of the film, corner is very simple to manage. The film corner is preferably inserted from a first side (13) of the wedge-shaped recess (12) with the steeper angle to a second shallower side beneath the clamping element (10). In addition the design is very robust during use due to its simplicity and is easy to clean. A clamping needle, clamping spring or clamping clip made of steel may preferably be selected as the clamping element (10) because these have very good strength properties and thus can absorb the clamping forces which occur on insertion of the film corner. It is of course also possible to use other materials, which have a sufficient strength. Metals, for example, aluminum and plastics, for example, polyamide and polyacetate, which may optionally be reinforced with glass fibers are suitable for this purpose in particular. The clamping element (10) is preferably designed as a rod. This geometry allows inexpensive manufacturing with a high precision because the clamping element, can be manufactured by a turning operation. However, it is also conceivable to have other shapes by means of which a clamping effect can be achieved.

In a preferred embodiment, the clamping element (10) may be sheathed by an adhesive material (15). An elastomer, which has a high coefficient of friction, is suitable for this purpose in particular. For example, silicone, thermoplastic elastomers (TPE) and thermoplastic polyurethanes (TPU) may be selected as the material. On insertion of the film corner, a clamping force occurs on the film because of the elasticity of the adhesive material (15), so that it is held in the desired position in rolling up around the central part (3).

All of the embodiments of the multichamber bag opening aids (1) described above may be furnished with handle elements (4) of various designs. The distal handle elements (4) as shown in FIGS. 4 to 6 preferably have a larger diameter than the central part (3). The handle elements (4) may be plugged, screwed or welded onto the central part (3) or otherwise connected to the central part (3). The central part (3) and the handle elements (4) may preferably also be manufactured in one piece.

In a first embodiment, the handle elements (4) may be shaped as a grip disk (16) as shown in FIG. 4. In addition a handle piece (17) may also be mounted on the grip disk (14) for improved transfer of torque, as shown in FIG. 5. The handle pieces (17) may be the same on both sides or may be aligned in an offset arrangement. An offset arrangement is preferred because this facilitates gripping during the rolling up operation and at the same time permits a better transfer of force.

In addition, the handle elements (4) may be provided with a roughened or partially elevated surface to provide a secure grip. In another preferred embodiment, the handle elements (4) may also be made of or coated with a rubberized material for a pleasant grip feel and in order to prevent the multichamber bag opening aid (1) from slipping away on a smooth surface.

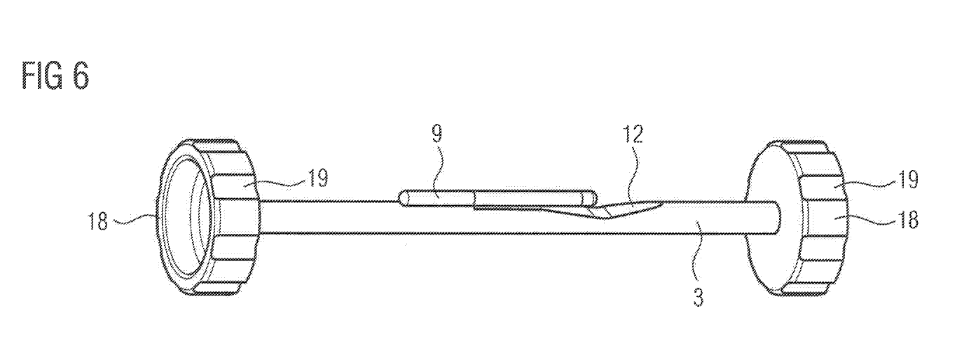

In another preferred embodiment, as illustrated in FIG. 6, the handle elements (4) may also be designed as a handwheel (18). In contrast with the grip disk (16), the handwheel (18) has surrounding gripping edge, which allows engagement with the handwheel (18) from the outside and also a high enough pressure to open the peel seam (5) can be created, with only a slight expenditure of force.

In a particularly preferred embodiment, the gripping elements (4) may be provided with indentations (19) in the form of a grip disk (16) or a handwheel (18). The indentations (19) as illustrated in FIG. 6 may be arranged at an angle of 45°, 120°, 180° or preferably 90° around the handle element (4), so that good grippability is also achieved and accidental slippage is prevented.

The various embodiments of the handle elements (4) may be gripped and/or held well even by a person of restricted motor capacity, permitting simple and convenient handling. They also allow convenient gripping when an edge area of the multichamber bag system (2) is rolled up, preferably a film corner around the central part (3) of the multichamber bag opening aid (1). The various embodiments of the handle elements (4) also make it possible to apply a sufficient force to roil up the partial area (20) of the bag and to compress the bag contents.

The multichamber bag opening aid (I) must have dimensional stability and should be easy to clean and resistant to cleaning agents. Thermoplastic or thermosetting plastic materials are therefore suitable for production of these bags. In particular polyacetal, polyamide, polyurethane, polypropylene, polyethylene, polycarbonate and/or polyvinyl chloride may be used.

In an alternative embodiment, the central part (3) of the multichamber bag opening aid (1) may be made of metal, preferably an anodized aluminum.

The multichamber bag opening aid (1) may also be produced by a cutting method or by an injection-molding technique. The central part (3) may also be formed as an ex tradable pipe.

FIG. 7 illustrates another multichamber bag system (2). This may be, for example, a multichamber bag (2) with chambers (6) that are separated from one another by the peel seam (5a). The bag (2) additionally comprises feed devices (7) and removal devices (8). A somewhat wider partial area (20) on a film corner is provided for the opening procedure. The bag system (2) may also include another chamber (21), i.e., a third chamber, which is provided, for example, as an empty chamber without a filling and is bordered by the peel seam (5b). However, the third chamber (21) may of course also be filled.

A method for opening peel seams will now be explained in greater detail on the basis of a multichamber bag system (2) as illustrated in FIG. 7. To do so, a partial area (20) of a multichamber bag system (2) is attached or affixed on the rod-shaped central part (3) of the multichamber bag opening aid (1), as described in the introduction, and rolled up around the central part (3) of the multichamber bag opening aid (1) by actuation of the handle elements (4) from, the partial area (20) of the multichamber bag system (2) until the pressure in the multichamber bag system. (2) exceeds the sealing pressure of the peel seams (5a), (5b) and they break open.

The partial area (20) is preferably an edge area of a multichamber bag system (2) comprising a film side or a film corner.

In a preferred embodiment, a partial area (20) of a multi-chamber bag system (2) is arranged around the central part (3) of a multichamber bag opening aid (1), such that the peel seams (5a) and. (5b) break open in a fixed sequence.

To do so, first the compartment (6) is rolled up from the partial area and the content of the compartment is compressed, so that the peel seam breaks open first by means of the multichamber bag opening aid (1). In doing so, the contents of the bag from the two compartments (6) are mixed. By rolling the bag (2) up further, the contents of the bag are compressed again until the peel seam (5b) also opens. The prerequisite for a defined successive opening of the peel seams (5a) and (5b) is that the peel seams (5a) and (5b) must have an increasing sealing strength in accordance with the order of opening.

### LEGEND

1 multichamber bag opening aid

2 multichamber bag system

3 central part

4 handle elements

5, 5a, 5b peel seam

6 chambers, compartments

7 feed device

8 removal device

9 indentation

10 clamping element

11 pivot point

12 wedge-shaped recess

13 first end of the wedge-shaped recess

14 second end of the wedge-shaped recess

15 adhesive material

16 grip disk

17 gripping piece

18 handwheel

19 notches

20 partial area

21 additional chamber

1. A multichamber bag opening aid (1) for opening peel seams (5, 5a, 5b) in a multichamber bag system (2) comprising a rod-shaped central part (3) having two distal gripping elements (4).

2. The multichamber bag opening aid (1) according to claim 1, characterized in that the central part (3) has a means for fixation of a partial area (20) of the multichamber bag system (2), preferably an edge area, especially preferably a film side or a film corner.

3. The multichamber bag opening aid (1) according to claim 2, characterized in that the means for fixation is designed as an indentation (9).

4. The multichamber bag opening aid (1) according to claim 3, characterized in that the indentation (9) penetrates completely or partially through the central part (3) in the longitudinal direction of the central part (3).

5. The multichamber bag opening aid (1) according to claim 2, characterised in that the central part (3) has a movable clamping element (10) as a component of the means for fixation.

6. The multichamber bag opening aid (1) according to claim 1, characterised in that the central part (3) has a wedge-shaped recess (12).

7. The multichamber bag opening aid (1) according to claim 6, characterized in that the wedge-shaped recess (12) preferably has a height of 1.0 to 0.2 mm, preferably from 0.8 to 0.4 mm, especially preferably from 0.6 to 0.2 mm up to the upper edge of the central part (3).

8. The multichamber bag opening aid (1) according to claim 2, characterized in that the wedge-shaped recess (12) partially protrudes beyond a clamping element (10) as the means for fixation.

9. The multichamber bag opening aid (1) according to claim 8, characterized in that the wedge-shaped recess (12) protrudes three-fourths, two-thirds, especially preferably one-half beyond the clamping element (10).

10. The multichamber bag opening aid (1) according to claim 8, characterised in that the clamping element (10) is designed as a clamping spring, clamping needle or clamping clip.

11. The multichamber bag opening aid (1) according to claim 8, characterised in that the clamping element (10) is sheathed with an adhesive material (15).

12. The multichamber bag opening aid (1) according to claim 1, characterized in that the handle elements (4) have a large diameter on the distal ends than the central part (3) and are designed as grip disks (16), a grip disk (16) with a handle piece (17) or as a handwheel (18).

13. The multichamber bag opening aid (1) according to claim 1, characterised in that the handle elements (4) are provided with notches (13).

14. The multichamber bag opening aid (1) according to claim 1, characterized in that the multichamber bag opening aid (1) is made of a thermoplastic or thermosetting plastic material.

15. A method for opening peel seams (5, 5a, 5b) in multichamber bag systems (2) using a device according to claim 1, characterized in that a partial area (20) of the multichamber bag system is attached to or affixed on the rod-shaped central part (3) of the multichamber bag opening aid (1) and by actuating the handle elements (4) is rolled up from the partial area (20) of the multichamber bag system (2) around the central part (3) of the multichamber bag opening aid (1) until the pressure in the multichamber bag system (2) exceeds the sealing pressure of the peel seams (5, 5a, 5b) and breaks them open.

16. The method according to claim 15, characterized in that the partial area (20) represents an edge area of a multichamber bag system (2) in the form of a film side, preferably a film corner.

17. The method, according to claim 16, characterized in that a partial area (20) of the multichamber bag system (2) is arranged around the central part (3) of the multichamber bag opening aid (1) so that the peel seams (5a, 5b) break open in a fixed sequence.
